(19) United States
(12) Patent Application Publication
(10) Pub. No.: US 2003/0070174 A1
(43) Pub. Date: Apr. 10, 2003

(54) Wireless video-on-demand system

(76) Inventor: Merrill Solomon, Potomac, MD (US)

Correspondence Address: NIXON & VANDERHYE P.C., 8th Floor, 1100 North Glebe Rd., Arlington, VA, 22201-4714, US

(21) Appl. No.: 09/971,684

(22) Filed: Oct. 9, 2001

(51) Int. Cl. H04N 9/00; H04N 11/00; H04H 1/00; H04N 7/173

(52) U.S. Cl. 725/98; 725/87; 455/3.05; 455/3.01

(57) ABSTRACT

A wireless video-on-demand system has controlled access and/or full VCR functionality. One or more low bandwidth wireless broadcast channels (e.g., associated with FM broadcast stations, or paging band spectra) is used to transmit encrypted high resolution video data in non-real time (low-data rate) to a plurality of receiver units. Received video information is gradually accumulated and stored in a local high capacity storage device and then processed to create a full length high resolution movie. An authorized user has controlled real time access viewing with VCR capability. If desired, each receiver unit may be sold with pre-loaded movies for immediate viewing of a selected pre-loaded movie while the receiver is still downloading other broadcast movies.

### FIELD OF THE INVENTION

This invention relates to wireless communication systems. More particularly, it relates to a method and apparatus that utilizes wireless broadcast medium (e.g., existing FM radio subcarrier channels, or FM subcarier audio portions of television (TV) channels, or one or more frequencies of pager frequency spectrum) to broadcast in non-real time (i.e., at relatively low data rates), encrypted high-resolution video data (or other data requiring higher data rates if transmitted in real-time) to a plurality of receiving units. Each receiving unit is capable of receiving such broadcast information and then reconstructing the encrypted and scrambled high-resolution video information into a format that can be viewed by the user in real-time, e.g., as a full-length movie. Each unit may also have full VCR type control functionality, such as, start, stop, pause, fast forward, rewind etc.

### BACKGROUND OF THE INVENTION

Electronic distribution of full motion video information was essentially begun with the introduction of television broadcasting.

First there were just the early TV networks broadcasting shows and/or movies on a predetermined schedule that was published in the local newspapers. People then knowing that schedule would, or would not, watch their favorite shows or movies depending upon their ability to be in front of the television set at the time the show was broadcast.

Later, with the invention of the videocassette recorder viewers got:

1. The capability to time-match the viewing of their favorite shows to their own schedules by recording the shows they wished to watch when the shows were broadcast, and then playing them back when they wished to watch them. They also got the capability to fully control their actual viewing experience, i.e., stop, start, pause, rewind etc. the show itself; and

2. The ability to watch, again at their convenience, previously recorded professionally duplicated movies. Those movies could either be purchased or rented. But in either case the viewers again got the capability to fully control their actual viewing experience, i.e., stop, start, pause, rewind, etc.

Of course, it wasn't thought of in the following terms at the time, but in actuality the VCR gave the consumer in one case video on demand (VOD), and in the other case pay per view (PPV) video on demand. However the latter was physical video on demand, not electronic, for the viewer had to make a trip to the video store to first pick out and then rent or purchase the physical cassette containing the movie they wanted to watch, and then in the case of renting, make another (and usually special) trip back to the store to return the movie. None-the-less, the viewer could watch the movie of his/her choice whenever they wanted to, and had complete control of their viewing experience.

If one wanted to electronically deliver Video on Demand, they first would have to ensure that that video data was high quality, at least equal to the quality delivered by a VCR. In order to transmit high quality video information (movies) in real time to the home (or anywhere), even utilizing the latest compression algorithms, data rates of approximately 1 Mega bits per second (for each available video) are required. It is currently thought that the vehicles to deliver those data speeds, cable or optical fiber, will become commonly available to the average home by about 2008 to 2010. However there are financial questions about consumer demand above and beyond the technical obstacles relative to data speeds. This is true because, if the cost of the delivery vehicle, when combined with the cost of actually viewing the movie, makes the total cost more than the average American wishes to spend, then that total cost could prohibit, or at least seriously slow down, the adoption of video on demand. And even if all of the above technical and financial obstacles are overcome, (as they may be), there are additional technical questions relative to integration of data speeds, system capacity, and consumer box capabilities, that would still have to be worked out before all consumers could watch any movie at a consumer's preference at anytime and still get full VCR (stop, start, rewind, pause) functionality under peak load conditions.

In order for a viewer to instantly see any movie that was ever made in any language, first that movie would have to be digitized and stored in at least one (most probably more than one) server, and that alone would be a huge undertaking. After that was accomplished, the delivery problem, would then first have to be addressed. Two such possible solutions to those problems are:

A. utilize a central site having very high speed two way communication links between the consumer and the distribution company, and a huge number of servers with just about unlimited memory capacity in order to insure that every person could watch a different movie, or even the same movie, at the same time yet fully control their viewing experience; and

B. utilize essentially the same system as above but with distributed memory and control. There now would be a system of huge servers, and a temporary storage device (possibly even in the viewer's home) all talking to each other in faster than real time.

In order for a viewer to instantly see only a predetermined limited number of movies:

A. a central site or distributed memory and control system, essentially described above could also be used; or

B. lots of broadcaster cable or satellite channels all broadcasting the same movies, for example, say 15 minutes apart (NVOD), but this system would not give the viewer VCR type control of his/her movie; or

C. first downloading the movie via some existing delivery vehicle, i.e., cable or satellite to a set-top box (STB) for later controlled accessed viewing.

### BRIEF SUMMARY OF THE INVENTION

The present invention provides a method and apparatus for overcoming all the above described inadequacies of delivery vehicle costs, administration, and lack of viewer control for approximately 95% of consumers, by utilizing the subcarrier(s) of an FM radio station, or the subcarriers of the FM audio channel of TV stations, or one or more paging band frequencies or the like to broadcast non-real time video data to a set-top box that receives, collects, decrypts, and reassembles that data for later controlled access real-time viewing (e.g., with full VCR functionally).

This invention creates a system that needs no technological advancements for it to work, and it could become operational and available nationwide in 12 to 18 months, not the 8 to 10 years that is still being estimated today for the more traditional approaches defined above. This new system would not only give the consumer movies on demand with complete VCR functionality, but do it at an affordable price (e.g., at about the same price movies rent for today, about $5). The system could deliver a movie on demand service at that low price, and in such a short period of time, because the delivery vehicle for the data stream is in existence today, and the cost of that delivery capability is extremely low. An exemplary system could work as follows:

1. A movie could be digitized and encrypted at a central location before being transmitted to the consumer.

2. When it is sent to the consumer it could be transmitted directly to them on a non-real time basis at a comparatively very low data rate over an existing and almost universally clearly received, but underutilized and very inexpensive vehicle (e.g., the subcarrier of an FM radio station or FM subcarriers of the audio portion of a TV channel or paging band frequencies or the like). Such FM sub-carriers are currently capable of reliably transmitting approximately 50-kilobits per second of actual throughput (maybe more), while much higher data rates are possible utilizing paging bands depending on the actual bandwidth of the paging band used. In the present invention, non-real time data transmission is defined as transmission of a quantity of video (or other) data over a time period that is longer than that required for normal real-time video display (or other data utilization). For example, if s nominally one hour video is transmitted in non-real time, then it will require substantially more than one hour to transmit all the data required to display that video.

3. The receiver or set-top box (STB) could then collect and store that data for later reassembly, decryption, and viewing.

A 50-kilobit per second data rate translates into approximately 1 VHS quality (or better) movie each day. This means that at that data rate approximately 30 movies could be downloaded to each box, per month, per sub-carrier channel. If higher data rates become possible then obviously more movies could be downloaded on each sub-carrier. Since today about 8 movies a month, or about 100 each year, account for approximately 85 percent of all revenue from video rental, using two sub channels, at the 50-kilobit data rate would yield more than 600 movies each year for the consumer to choose from, therefore satisfying the viewing appetites of probably 95% of all consumers, and at the same time, potentially giving the studios significant additional revenue and profits from Kid, Family, Art House, or Adult movies as well. Because microprocessors have become so powerful and so cheap, and side channels or paging bands are also relatively inexpensive, using significantly more than two channels or paging bands is also feasible.

The consumer would have to purchase a special STB to receive the movie, but the box would be fairly inexpensive for it essentially could be little more than an FM receiver attached to a modem front ending a special-purpose computer chip, which would in turn transfer the movies for storage onto a fairly large capacity hard disk. And furthermore, that STB could, for no additional charge, also give the consumer all of the functionality that is in today's digital video recorders (TIVO®, Replay®, and Ultimate TV® boxes), including broadcast and cable program scheduling without the need for a telephone connection.

As far as the consumer is concerned he/she need not know or care that it might have taken a full day to download a single movie. The consumer now has a full function VOD capability without having to wait 10 years for a broadband pipe into his/her house or to pay a relatively high fixed monthly fee for broadband access (today about $50 per month), or the need for the relatively expensive, and somewhat hassle filled experience to both install and use a satellite dish.

In brief, this invention:

utilizes the existing broadcast media to download (broadcast) on a non-real time basis, i.e., at comparatively low data rates, directly to the consumer an encrypted data stream, and then

utilizes a receiver box to collect, reassemble, and decrypt that data stream into a watchable real-time VOD movie after the consumer has paid a fee. The receiver box could be stand-alone, with no telephone line connection, and self-actuated to receive the broadcast signal once it is plugged in, or after the viewer has enrolled in a billing activation system.

The system could be extremely user-friendly. The consumer, without any action on the consumer's part to acquire the movie, could watch any movie that was by then stored in the consumer's box at any time the consumer wanted by just pointing and clicking a consumer's remote, if two way messaging technology was employed in the receiver box, or by making a 15 second phone call to an 800 telephone number if it was not.

One exemplary system is made up of three different, but fully integrated parts:

1. The Encoding and Distribution Sub-system (EDS)

2. The Activation and Accounting Sub-system (AAS)

3. The actual receiver/recorder set-top box (STB).

Although not discussed in detail, in order to minimize piracy there preferably should be several encryption and data scrambling algorithms embedded in the system.

The Encoding and Distribution Sub-system is important to an “Hour Glass” distribution strategy. It may receive two; possibly three or more forms of raw data, encrypt them, and then distribute them to the set-top box (STB). For example, it may receive:

1. Master copies of the movies from the studios.

2. Activation codes for individual set-top boxes from the Activation and Accounting Sub-system.

3. Possibly TV program listings from various sources.

After receiving, and then encoding, those items of information, it distributes them to each participating local FM radio station or TV station (i.e., an FM transmitter) or paging band transmitter by the most economical means, which today is satellite. Each transmitter then broadcasts those different, but possibly intermixed, data streams to the individual receiver/recorder set-top boxes.

In order to minimize a possible contradiction in the system architecture and also add some flexibility into the system there may be some electronic housekeeping performed at each transmitting station before the data streams are broadcast. A transmitter or a transmitting station referred to herein refers to a transmitting station related to FM radio stations or a transmitting station related to FM subcarriers of audio portions of TV channels at a TV station or a transmitting station for paging band frequencies or the like.

Every system, no matter what its intended application, is preferably designed to be as simple to use as possible. For this exemplary system, since the movies are automatically downloaded to the STB, without any pre-selection by the consumer the only actions the consumer need to take are to choose the movie he/she wants to watch, and then order it. Herein lies a possible contradiction. The very reasons that make this system concept so appealing (e.g., that it is a broadcast model, which means it can reach an enormous potential audience very cheaply, and that FM sub-carriers and/or paging band spectra are even lower in cost than other broadcast technologies because there is so little demand for their low speed transmission capabilities) are also possible obstacles to making the system user friendly relative to ordering movies because, one must remember, broadcast is a one-way medium.

So a separate but fully integrated system may be established to accomplish the ordering task, and overcome that possible contradiction. That may be accomplished, for example, by having the consumer call an 800 telephone number site to order the movies, and then have that system (the Activation and Accounting Sub-system), give the consumer activation codes to the Encoding and Distribution Sub-system for final delivery to the consumer's STB.

However there is potentially more. Since this is a broadcast model with the FM sub carriers (or other broadcast media) having a limited bandwidth, transmitting an activation code for a STB in one city, needlessly over the FM sub-carriers (or other low bandwidth broadcast media) of 50 other cities, would be extremely inefficient. Therefore although the satellite system will distribute activation codes for all cities, to all cities, each city will preferably have a smart router that will select and then broadcast only activation codes for the STBs in that city.

In addition to the proper selection of activation codes, because the central computer can always be monitoring the demand for activation codes, and the amount of data that can be sent over locally broadcast leg of the system at any one time is fixed, and is relatively low, the system may also dynamically balance video and activation code data streams between the satellite and locally broadcast portions of the system depending on the activation code demand. As an example, the data streams for both the satellite and local broadcast segments of the system at 3 AM on a Tuesday morning would probably be 100% video, and at the maximum data rate of the local broadcast segment. However, the data streams at 7 PM on a Friday night would most probably be 100% activation codes, and the satellite portion would most likely be at a data rate 50 times the local broadcast segment data rate (if there are 50 cities).

Also, since each transmitter station will probably include a smart router, and different cities will most probably have a different number of transmitter stations and, furthermore, since each STB may also be “smart” by including a smart receiver a greater number of movies may be transmitted to each STB than the maximum receiving capacity of each STB for each STB may be programmed by the user to selectively receive movies according to their choice from among all the movies that are transmitted. For example, assuming each month that 50 new movies can be received and stored in each STB, but each city has the capability to transmit 100 movies, each STB could be programmed by its owner to receive more action movies than drama, or more Family movies than Art House movies, etc. The total number of movies that are transmitted, and the specific selection of each movie is still under the control of the video source, and encoding and distribution system. The consumer, however, is now given even greater choice of movies to watch, thereby increasing the total number of people that potentially would purchase a STB and become a subscriber.

The Activation and Accounting Sub-system does just what its name implies. Based on today's costs it may be a telephony-based computer system with a huge database, but it is possible that in the future as cellular communications increase in robustness, that future boxes could contain two-way communications, and the system would then not be telephony-based.

One exemplary system first enrolls each subscriber and records his/her individual STB ID number as well as his/her credit card and telephone numbers. It subsequently processes orders from each subscriber for the movies that he/she wishes to watch, collects money from a credit card company, and then issues payments to the studios.

The STB itself may actually be quite simple in concept, but because of all of the security measures, and user interface issues, it will preferably be a very sophisticated piece of equipment. Principally it will contain:

a self scanning receiver/modem module,

probably two TV tuners,

an up-dateable microprocessor that will not only control the user interface, and its ability to record and play back live TV, but also upon receiving the proper activation codes decrypt the movie selected and permit it to be viewed, and

a large capacity hard disk

Possibly the best way to describe an exemplary system is to detail how a consumer could actually use it:

1. The consumer could first purchase a Receiver/Recorder Set-Top Box from the usual sellers of such consumers electronics.

2. The consumer would then attach the STB to their TV as they would a VCR or DVD player.

3. Two things happen after the box is installed. One is automatic, and the other one the purchaser must manually do:

The moment the Box is plugged into the electrical system of the house the receiver/modem module immediately starts to scan the frequency spectrum looking for the sub-carriers, paging bands, etc. in that area that are used by the service, it finds them, locks on them, and begins to download movies.

The consumer must enroll in the service. He/she can do that by making a less than two minute phone call to an 800 telephone number. (This could also be accomplished over the Internet).

4. The consumer calls the 800 number and tells the operator:

a. His/her Receiver/Recorder Box identification number which would then be displayed on his/her TV screen

b. The credit card number that he/she wishes to use to charge the fees to (there could also be a prepaid option), and

c. Invisibly to the consumer the system would also capture his/her telephone number through its caller ID function.

The consumer now has the capability to watch whatever movie that is in the STB whenever he/she wants to do so. All the consumer needs to do is select a movie and call the system. A call could go as follows (The system could be fully automated with speech recognition):

The system answers the consumer's call by saying, “Good Evening Mr. Smith what movie would you like to watch?”

The consumer says the name of the movie such as “Coyote Ugly”, (or enter the movies number via the touchtone key pad on their telephone.

If this system was unsure what the consumer said, it could confirm the movie by saying its name back to the consumer. If it was sure what movie was ordered it would do the following two things simultaneously:

Create a unique activation code from the day, date, STB ID number, movie selected, city code, etc. and send it to the distribution system where it would then be transmitted to the receiver box. (Once that activation code was received by the STB its algorithms would check to insure that the code was authentic, and if it was, then decrypt the movie for viewing.) and

Inform the consumer how long it would take before they could watch the movie. The system could say, “Your movie will be activated in approximately 30 seconds, or 1 minute, etc.”

The system would then automatically charge the consumer's credit card for the viewing, and credit the Studio as well. Sometime later when the money was actually transferred from the credit card company, the system would also pay the Studio.

This exemplary system description describes only the VOD capabilities of the STB. However the system could also download the appropriate TV schedules for the different local areas, and the STB as previously stated, could also give the user the capability to record and play back live TV.

A present exemplary apparatus and method utilizes the subcarrier(s) of an FM radio station or the FM audio channels of a Broadcast TV station, or one or more paging band frequencies to broadcast video information to a set-top box (STB) in non-real time (i.e., a very low data rate), the STB being capable of receiving, collecting, decrypting, and reassembling the received video information for controlled access viewing, at a later time, with full VCR functionality. FM radio station or FM audio channels of a broadcast TV station or paging band transmitters are generally represented as FM transmitter station in the figures in the present application. The first exemplary embodiment described herein uses one or more FM subcarrier frequencies associated with radio or TV stations to transmit encrypted high resolution (e.g., VCR quality) video information in non-real time (very low-data rate) to a plurality of receiving units (“set top boxes” (STBs)). For the purposes of the present invention, “high resolution” video information should be considered as video information having a resolution of at least 352 pixels/horizontal line (and comparable vertical pixel resolution) for VHS quality real-time video.

The general concept of collecting video content via a box in the viewers home for the 100 movies each year (20% of product) that generates 90% of the possible revenue, is not new. What is new is for that delivery vehicle to be the very inexpensive, but nationally available, extremely low data rate capable, sub-carriers of FM radio stations, or FM subcarriers of audio channels of TV stations, or one or more paging band frequencies.

This idea could actually create an entirely new video content distribution network equal in some ways to existing TV broadcast, cable, or satellite networks. This invention at 50-kilobits per second can now deliver two hours of VHS or better quality programming every day per low data rate broadcast channel. If plural such channels are used, a fairly wide bandwidth from the paging bands, or more advanced higher bit rate modems would provide even more movies a day (e.g., two FM sub-channels providing two movies a day equaling 50 plus movies a month). If 12 FM sub-carriers were used, which would be available for probably 80% to 85% of the population, that would provide 24 hours of broadcasting. One could even do “live” programming if desired by sending packetized data down all 12 subcarriers at the same time. However, the complexity required to insure timely and appropriate re-assembly of packet data, from 12 sub-carriers and the cost of the storage medium might substantially increase the cost of set-top boxes.

In a presently described exemplary embodiment, video information received in each STB is gradually accumulated and stored in a local high capacity storage device. The received and/or stored video information is processed to create and display a full-length high-resolution movie/video (e.g., upon receiving an appropriate activation code). Other content, such as, for example, received real-time live television broadcasts, cable TV broadcasts, etc., may also be stored and processed for later display while low data rate non-real time video information broadcast on FM subcarrier channels, or broadcast using one or more paging band frequencies. Each STB may, if desired, also have a capability to receive FM/AM radio broadcasts.

Activation codes may be selectively transmitted to enable an authorized user to view the video data selected from the accumulated and stored video data, with full VCR capability. If desired, each STB also may be sold with pre-loaded movies such that a user may immediately start viewing a selected movie from the available preloaded list, while the STB is continuously downloading other video information/movies that are being broadcast on various FM subcarrier frequencies or pager frequencies.

Each STB may, if desired, include more than one receiver for simultaneously downloading video information broadcast on more than one FM subcarrier or other broadcast channel. Provision of more than a single FM receiver in a STB enables a user to download a larger number of movies per unit time (e.g., downloading plural movies in parallel, each on a respective FM subcarrier channel). Alternately, portions of a single movie may be broadcast in parallel on various FM subcarrier channels, and later a full length movie may be reconstructed from the received portions of the movie, thus reducing the download time for the movie. Each STB may be further programmed to automatically, or upon viewer command, purge old video information to make room for the newer, latest, video releases as they are broadcast over the FM subcarrier channel(s).

In operation, encrypted video information is broadcast on one or more FM-subcarrier channels associated with radio or TV stations. Video information may also be broadcast on one or more paging band frequencies. Upon activating the STB, one or more FM receivers included in the STB may automatically scan the applicable broadcast frequency spectrum looking for the portion(s) carrying encrypted video information for this system. Once found, the STB locks onto such broadcast media to download encrypted video information. Encrypted video information is continuously downloaded at a non-real time low data rate to a high capacity storage device local to the STB. The downloaded video information is processed, which may include such functions as, for example, sorting and reassembling received video information, to reconstruct the data into a high resolution full length movie.

If a “synchronous” system is implemented, meaning that all video data is transmitted simultaneously to all set top boxes, then the system may also need to dynamically balance the broadcasting of encrypted video information with broadcast of activation codes (e.g., between a satellite and distributed down-link FM radio stations) depending on the demand for activation codes at a given time. There may be less of a need for balancing functions if an asynchronous type of distribution system is adopted, however the complexity and sophistication of the accounting and activation, and encoding and distribution systems dramatically increases.

In either a synchronous or an asynchronous system, a user intending to watch a movie from a list of movies previously downloaded into the user's STB, may communicate with a central computer system to obtain appropriate activation code(s). In this exemplary approach (which may involve two-way communication links), in order to receive activation codes, a user may have to establish an account that is periodically debited by an accounting system automatically receiving usage information from a STB. Upon collecting a fee (or otherwise insuring payment) and authorizing the user, the activation code for the user selected movie may be broadcast to the user's STB to enable stored video information to be decrypted, thus enabling the user to watch the selected movie with complete control (for example, VCR functionality) over the displayed movie.

In other embodiments, the activation code could be spoken verbally directly to the subscriber over the telephone when they called the accounting and authorization sub-system to watch the movie of their choice. The subscriber through the remote control of STB, or by other direct means, enter that authorization number manually into their STB.

In some embodiments, a user may obtain activation codes by establishing a connection between the STB and a telephone line (e.g., using modem communications) directly or indirectly (e.g., such as by conventionally transmitting digital data from the STB through electric house wiring to a modem that is actually hardwired to a Public Switched Telephone network (PSTN) telephone line connection. The user may then interface with the central computer system directly from their STB using their remote control to select a movie, and their STB will then automatically connect to the Activation & Accounting System (AAS) of the central computer system.

In another embodiment, encrypted video data from the central computer system may be retransmitted to a plurality of set top boxes using one or more paging band frequencies. In this embodiment, encrypted video information from the central computer system may be transmitted via a satellite to a pager transmission station/tower instead of an FM radio station or a TV station. Since the bandwidth of paging bands can vary greatly, it is possible that the amount of video data that is transmitted using paging frequency spectrum could significantly more than amount of video data, per unit time, than using FM subcarrier channels.

Alternatively, any other conventional fee-charging system could be used. For example, a pre-paid credit could be debited within the STB. The STB could accumulate charges and periodically upload billing data to a central billing computer (e.g., in response to polling or by locally initiated outgoing calls via the PSTN). Such communications may or may not involve a two-way data exchange.

Although so far discussed only in terms of delivering video data to users, the herein-proposed VOD systems may generate data streams that include audio, games text, graphics and other data types. All references to video data in the specification and claims are intended to include data that comprises either entirely one of these data types or some mixture of them. Nothing herein should be taken to limit the present invention to the storage and transmission of the specifically enumerated data types only.

### BRIEF DESCRIPTION OF THE DRAWINGS

These and other benefits and advantages of the present invention will become apparent to those skilled in the art from the following detailed description, taken in conjunction with the accompanying drawings (wherein one or more presently preferred exemplary embodiments of the invention is shown and described, simply by way of illustration).

FIG. 1 illustrates an exemplary high level schematic of an exemplary video communications system in accordance with the present invention;

FIG. 2 illustrates an example embodiment of a more detailed exemplary schematic of the video communications system as shown in FIG. 1;

FIG. 3 shows a detailed schematic illustrating exemplary details of a set top box such as shown in FIG. 2;

FIG. 4 is a flow chart illustrating an exemplary operation of the present invention;

FIG. 5 shows an exemplary embodiment of the present invention providing two-way communication between remote users and the activation and accounting system as shown in FIG. 2;

FIG. 6 shows details of an exemplary activation and accounting system as in FIG. 2;

FIG. 7 shows details of an exemplary encoding and distribution system as in FIG. 2;

FIG. 8 illustrates another embodiment of the present invention as illustrated in FIG. 5; and

FIG. 9 illustrates another embodiment of the present invention showing transmission of encrypted video information using paging frequency spectrum.

### DETAILED DESCRIPTION OF EXEMPLARY EMBODIMENTS

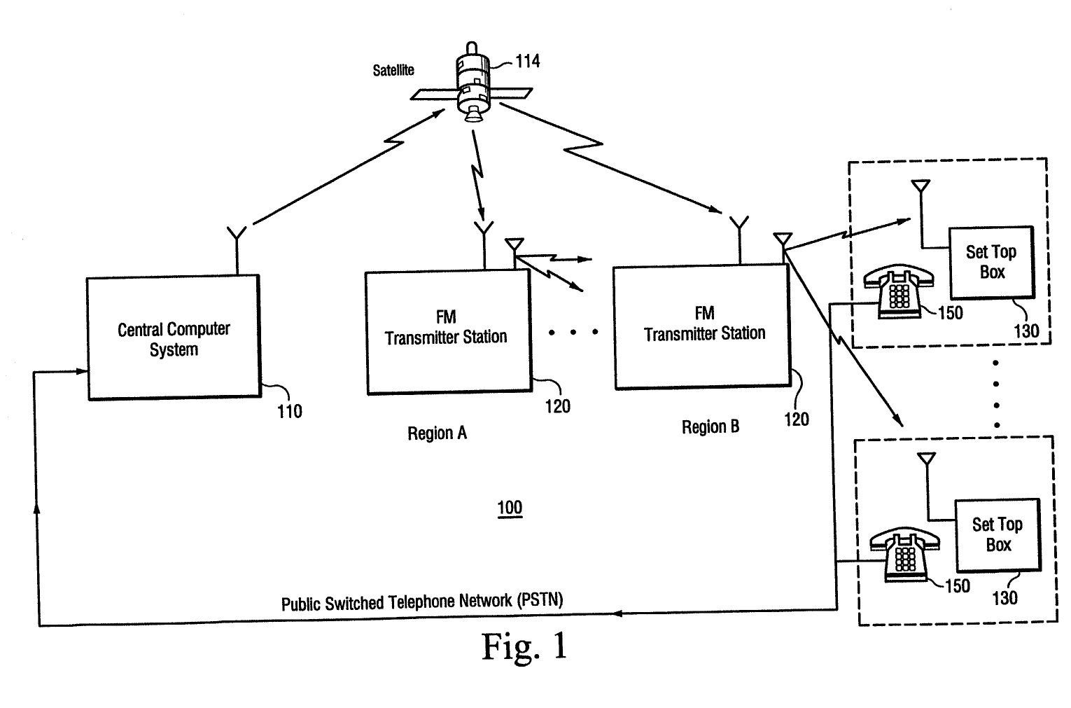

Referring to FIG. 1, a wireless video communication system 100 is generally indicated in a high-level block diagram fashion. Video information processed by central computer system 110 is transmitted to satellite 114 for retransmission to a plurality of conventional FM transmitter stations 120. Each of the FM transmitter stations 120 may be located to cover a corresponding geographic region, or a portion of a geographic region. Thus, video information relayed from satellite 114 may be further re-transmitted via FM subcarrier channels of the FM transmitter stations over wide-ranging geographic regions. It may also be possible to broadcast encrypted high-resolution video information on FM subcarrier channels of TV stations.

Generally, an FM signal includes more bandwidth than is required to send a high fidelity signal. Typically, an FM station is allowed about 100 kHz of bandwidth, and stations are spaced 200 kHz apart, and the frequency response extends only up to 15 kHz, thus leaving unused bandwidth. FCC regulations allow “Subsidiary Communications Authorization” (SCA), also generally referred to as “Selective Call Acceptance” or “Subsidiary Communications Service” (SCS), frequencies to carry a multitude of signals, both digital and analog, at any frequency and bandwidth, so long it does not affect the main channel of transmission or extend the bandwidth of the FM station beyond the 100 kHz allocation. A typical traditional SCA channel is an FM subcarrier wave (at, for example, 41 kHz, 67 kHz, or 92 kHz) carrying voice signals (with a frequency response of about 5 kHz) on a much higher frequency FM carrier wave. The unused bandwidth of the FM radio stations may now be used to provide low cost video-on-demand services with full VCR functionality.

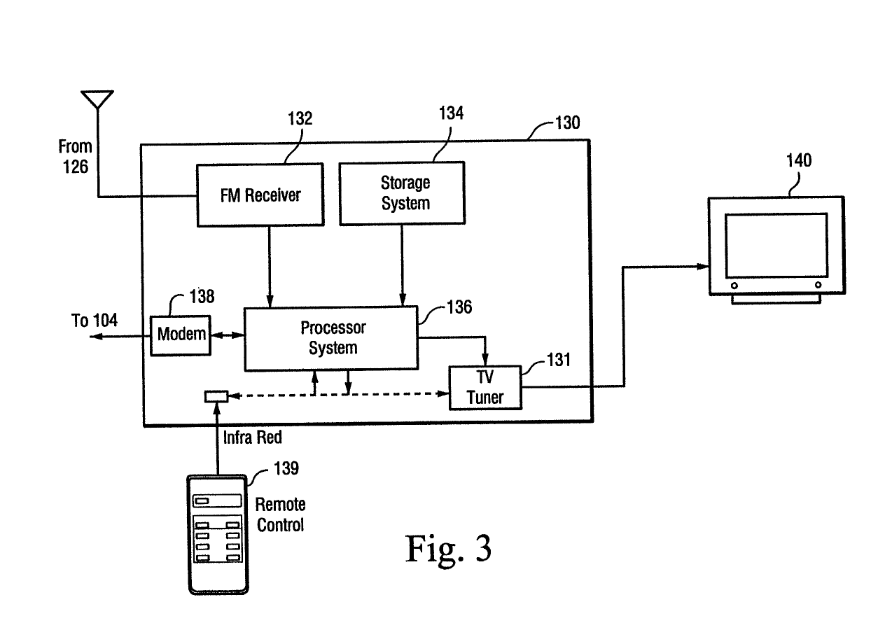

Still referring to FIG. 1, for the sake of brevity, FIG. 1 discloses only two FM Radio or TV stations 120 generally indicated as FM transmitter stations 120 and two STBs (set top boxes) 130. The present invention, however, may include a great plurality of such FM radio or TV stations and a great plurality of STBs. Video information received at FM radio or TV station 120 is rebroadcast on its FM subcarrier channels to STBs 130 in non-real time low data-rate (e.g., on the order of 50 kbps). Each STB 130 downloads the broadcast video information, and gradually accumulates downloaded video information in a high capacity local storage device 134 (FIG. 3). Upon obtaining appropriate activation codes from the central computer system 110 (or otherwise insuring appropriate payment), a user associated with a given STB 130 is enabled to view accumulated video information (e.g., a movie), stored in the local storage device 134 (FIG. 3), with controlled access and display including complete VCR functionality which includes, for example, fast forward (FF), fast reverse (FR), pause, freeze frame, stop, and play functions. The video information may be displayed on a display device, such as, for example, a television.

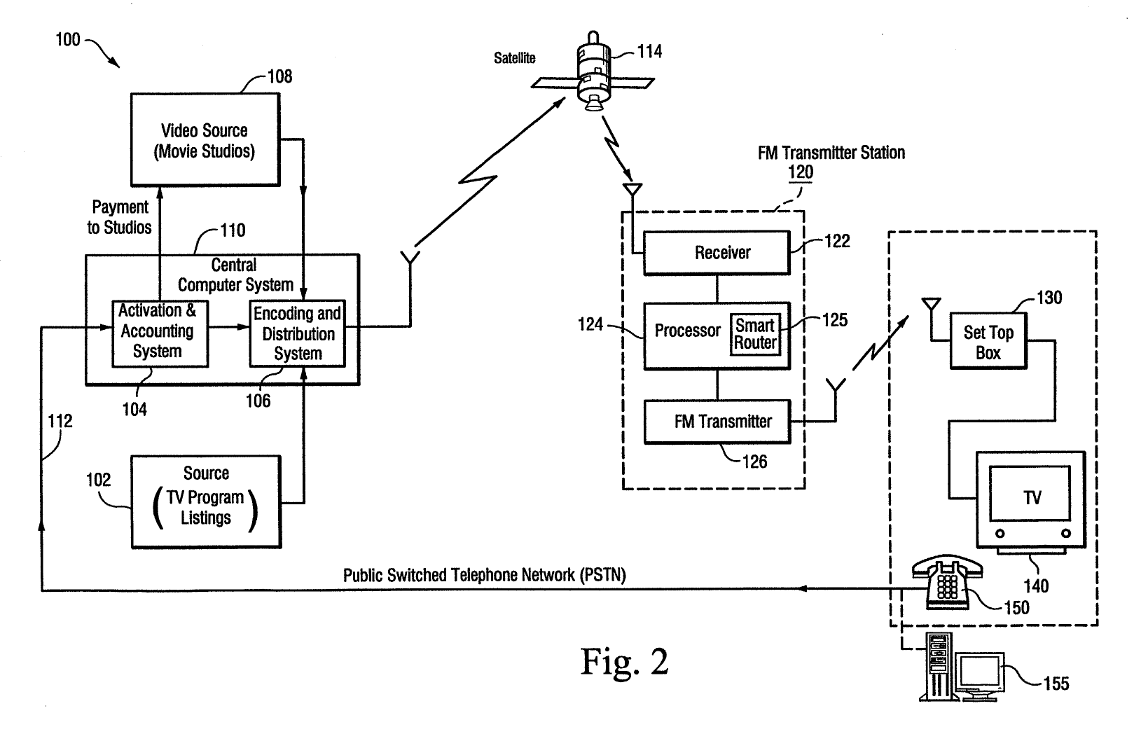

Referring now to FIG. 2, there is shown a more detailed schematic of the exemplary video communications system in FIG. 1. Digitized video information, such as, for example, movies received from source 108, which may include movie studios, are encrypted at the encoding and distribution system (EDS) 106. Video information received at EDS 106 is high quality video information which after transmission to the STB is capable of reconstruction and display into a full-length high-resolution movie with complete VCR functionality. The EDS 106 may also receive such information as, for example, TV listings, from other source(s) 102. In an experiment emulating the data link from an FM station 120 to a STB 130, a throughput of 57 kbps was achieved using mobile communication devices. However, a throughput of about 100 kbps may be achieved using stationary communication systems.

If the data link to an STB is capable of downloading more data per unit time than the STB is capable of accepting for local storage (e.g., due to limited receive bandwidth and/or limited local processing or storage capacity) then a “smart” receiver may be used having a front end, capable of selectively receiving only a desired portion of the data available on the data link. For example, if 100 videos per month are available via the data link, a given STB may be user-configured so as to selectively receive only a desired subset of those that are available.

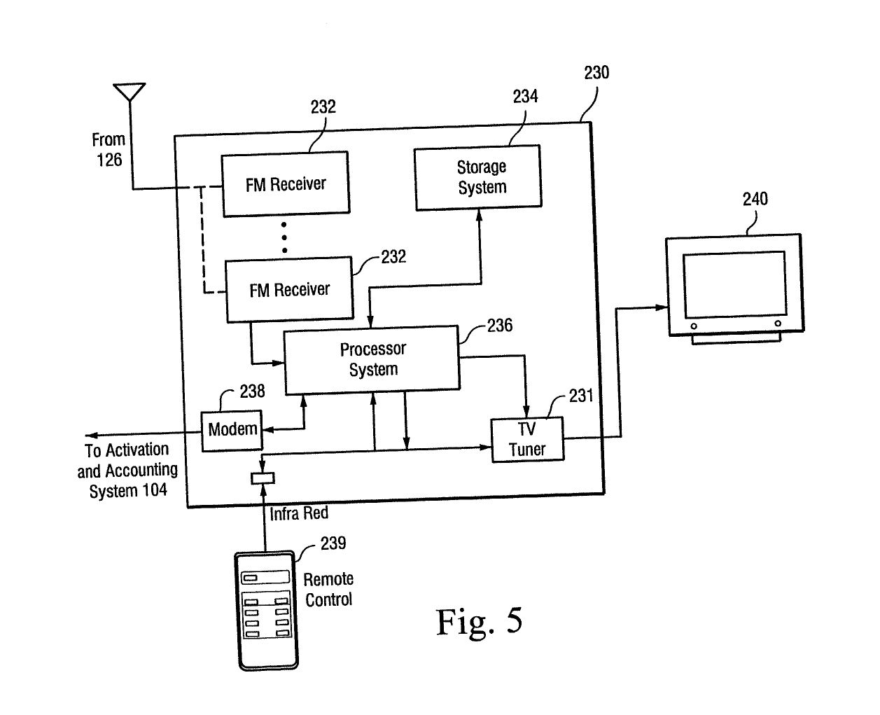

The EDS 106 also receives input from the Activation and Accounting Sub-system (AAS) 104. The AAS 104 may include a local or a remote database for storing accounting and contact information of the users. The AAS 104 may further include a voice recognition unit (VRU) front end for receiving and processing calls made by users requesting activation codes because they wish to watch movies or other video content. Both video and activation code information received by the EDS 106 are transmitted to satellite 114 which relays the encrypted data to a plurality of FM radio stations 120. Further details of AAS 104 are set forth and discussed with respect to FIG. 5.

Each FM radio station 120 may include a satellite receiver 122 for receiving encrypted movies from satellite 114, a processor system 124 for processing encrypted movies for rebroadcast on FM subcarrier channels (which may typically now be under-utilized or not used at all). The processor system 124 may further include a “smart router” for intelligently routing activation codes specifically directed to a region wherein a user requesting the activation codes is located. The encrypted movies are re-broadcast by FM transmitter 126 on a non-real time low-data rate, for example, on the order of 50 kbps/sec or less. It will be understood by one of ordinary skill in the art that throughput on any one sub channel may be increased, depending on the sophistication of the data transmission algorithms used. On the other hand more than one sub carrier could be utilized at a given FM station to also increase the throughput. Of course the satellite link may also convey the video data in non-real time (i.e., either faster or slower than real time video display time).

Each FM radio station 120 may cover a geographic region encompassing a part of a single city, or several cities. Encrypted movies transmitted on FM subcarrier channels are received by each of a plurality of STBs 130, each STB 130 being located at a corresponding user's premises. The available bandwidth of FM subcarrier frequencies available from each FM radio station is limited.

The limited bandwidth of each available FM subcarrier channel for a given region may create an inefficient system if activation codes for a STB located in one city are needlessly broadcast over FM subcarriers of all other cities. Therefore, to alleviate this potential problem in this type of exemplary system, the central computer system 110 preferably monitors demand for activation codes, and dynamically balances such demand with video information that is to be re-transmitted on the FM subcarrier channels. Although, the amount of information transmitted using paging frequency spectrum is greater compared to transmission via FM subcarrier channels, a similar balancing approach may be adopted, if necessary.

The concept of dynamic balancing may be better understood by the following exemplary situations:

(1) Case 1: During odd hours (e.g., 3 AM on a Tuesday) when essentially no orders are being received from customers from various cities, it is likely that data streams for both the satellite and FM subcarrier segments of system 100 could be almost 100% video, which in turn means that the video data may be broadcast at the maximum data rate of the FM subcarrier channels. Therefore, the amount of video information transmitted on a satellite link to all the cities would be (one)×(Maximum data rate of FM subcarrier channel), if the system was configured to be a synchronous one.

(2) Case 2: during peak viewing hours, such as, for example, on a Friday evening, system 100 may receive numerous orders from customers from all cities requesting activation codes. Since the available bandwidth of each cities FM subcarrier channels is the limiting factor for a synchronous system and that leg of the system is now substantially filled with activation codes to satisfy user requests, no bandwidth would be available to send video information. Therefore, only activation codes could be transmitted, but since a smart router could be used in each city, the satellite system could be transmitting data equal to the number of cities in the system, times the maximum data rate of the slowest cities sub channel.

(3) Case 3: In this exemplary scenario, some cities may have ordered codes sufficient to use 100% of the available bandwidth of their sub channels, and some may be capable of receiving 100% video information (i.e., because no actuation codes are then being ordered), but because this system is a synchronous system, and the limiting factor for the entire system is the data throughput of any one cities sub channel, even though only one cities throughput is 100% activation codes, no city would receive video information.

All of the above examples are for a synchronous system, meaning that all STBs receive the same video information simultaneously. There are reasons, such as guaranteeing the Studios that all moves, from all Studios, will be available to all customers, at the same time that a synchronous system be used. However, there are reasons, such as more efficient use of bandwidth, being able to distribute different genres of movies to different geographical areas of the country, why an asynchronous system might be implemented. The principal differences between a synchronous and an asynchronous system are in the greatly increased complexities of the Accounting and Activation Systems, and the Encoding and Distribution systems.

Thus, as one can see from the above exemplary scenarios, dynamic balancing of the demand for activation codes with video information, and intelligently routing the received information, would be necessary to ensure successful long-term system operation if this type of embodiment is implemented.

FIG. 3 shows details of an exemplary STB 130. Each exemplary STB 130 includes at least one FM subcarrier receiver 132, high capacity storage system 134, and processor system 136. Encrypted video information transmitted on one or more FM subcarrier channels from FM radio transmitter(s) 126 is received by the FM receiver 132. Video information transmitted on FM subcarrier channels is processed by a processor system 136 and accumulated for storage in the high capacity storage device 134 of the STB 130. A user of STB 130, if not already authorized to view stored video data, could be required to submit a request to receive activation codes from AAS 104 of the central computer system 110 (FIG. 2) which could create and forward such activation codes to the EDS 106 for retransmission to the requesting user.

In order to construct activation codes, a cryptographic algorithm may use criteria, such as, for example, date, time, and location of the user request, identification number of a user's STB, and identification data of the requested movie, in order to generate a robust cryptographic code. The encryption algorithms may also be rotated in cycles in order to further ensure secure transmission of activation codes to a user.

Upon receiving and verifying the authenticity of activation codes by a user of a select STB 130, encrypted video information stored in storage device 134 of the select STB 130 is retrieved and processed in processor system 136 for display. Processor system 136 may perform such tasks as decompression, decryption, sorting, and rearranging decrypted video information. These processing tasks are undertaken to create a high resolution full length movie in a predetermined data sequence for viewing on a display device that may be interfaced to STB 130. The processor system 136 may be a microprocessor system having algorithms for performing the above-noted tasks. Storage device 134 may be a conventional high capacity storage device, such as, for example, optical, magnetic, or any other high capacity rewritable data storage device.

In addition to performing various processing tasks as noted above, the processor system 136 may also be programmed to delete/purge old video information accumulated and stored in the high capacity storage system 134. Old video information may be purged on a first-in-first-out (FIFO) basis, or a user may provide instructions to processor system 136, via a remote control device 139, to selectively delete video information stored in the storage system 134.

In a typical one-way cable or pay-per-view satellite system, a user communicates to a program provider typically via a telephone to take advantage of a particular service. The provider then broadcasts a code, specifically addressed to the subscriber's decoder, unlocking stored features, for example, providing the subscriber's site with a cryptographic key capable of descrambling an encrypted program. The present invention may make general use of this scheme. However, rather than to provide a code or key associated with a particular channel or program, the central computer system 110 preferably distributes activation codes that unlock an amount of viewing, either in terms of a number of hours, numbers of time viewed, or a level of credit, etc. either of which may be used by a particular user as desired. As noted above, with the ability to view stored video information with a remaining credit balance, a user may readily communicate again with the central computer system 110 to increase the reserve available for viewing. The user may then be billed for the amount of credit requested, either as it is used, or pre-billed at the time of the request before actual use. It should, however, be noted that a user may be required to communicate with the central computer system 110 (FIG. 1) in order to receive activation codes, and the mode of communication may be through a typical PSTN line or a PSTN line connected to a STB (e.g., via low-speed modem(s) enabling communication via household electric supply wires from the STB to the PSTN line of a user's home).

Although perhaps less desirable, a user might be asked to manually enter an authorization code (e.g., via a hand held remote controller key pad). Thus a user might telephone for an authorization code which, when supplied via audio telephone responses could then be manually keyed into the STB to permit local viewing of the desired local data store.

In the event that the exemplary system is two-way in nature, as illustrated in FIGS. 3 and 5, the activation and accounting system (AAS) 104 may receive a request for activation codes directly from a STB 130, 230. Thus, in this approach, a user is not required to use a regular PSTN line to communicate with the central computer system 110 (FIG. 1) for requesting activation codes from the AAS 104 (FIG. 1). Rather, a modem 138 may be communicatively coupled with a land-line or a cellular telephone line, thus having a capability to directly communicate with the central computer system 110, and enabling a two-way communication. However, with a one-way system, program selection and actual use information will be communicated through another medium, for example preferably in advance, via telephone, as already discussed, or, alternatively, with separate RF or computer network interconnection to the AAS 104. A STB could contain a super low speed modem that would work through the electric wires of the house and then at some convenient telephone near some electric outlet the modem is attached to the telephone line.

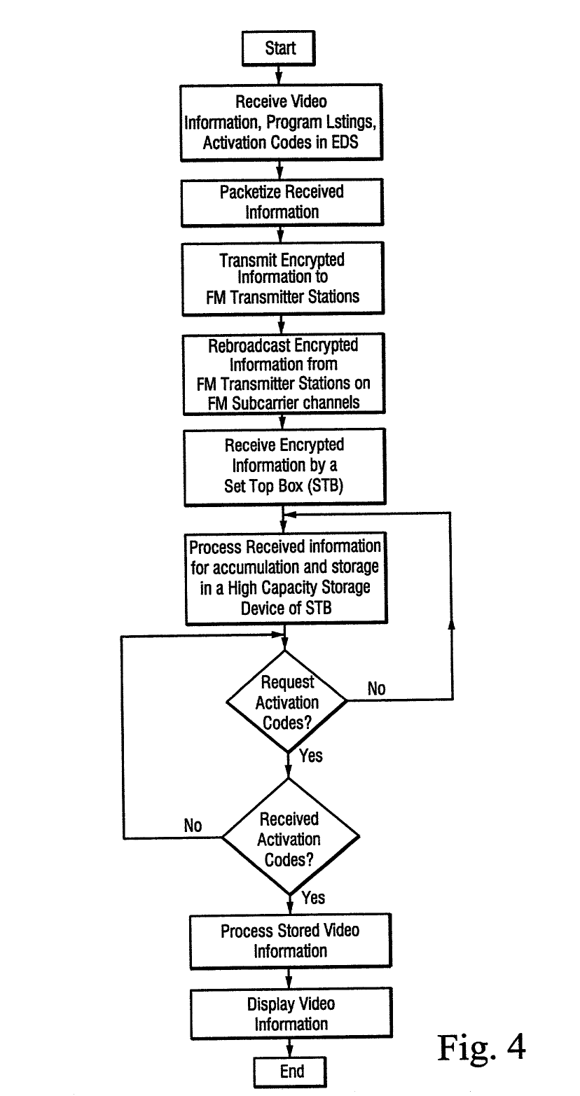

In operation, and as illustrated in the exemplary flow chart of FIG. 4, encrypted video information is broadcast on FM-subcarrier channels via FM transmitter 126 as discussed above. Upon activating the STB 130 (i.e., powering the STB 130 by the user plugging it into a power source after purchase), FM receiver 132 included in the STB scans the spectrum of then available FM subcarrier frequencies to identify and lock onto one or more frequencies carrying encrypted video information broadcast from transmitter(s) 126. Once an FM subcarrier frequency carrying encrypted video information is located and locked by an FM receiver, the encrypted video information is continuously received at a low-data rate (for example, on the order of as low as 50 Kb/sec or less) to the STB 130 by the processor system 136 where it is processed for storage in a high capacity storage device 134.

The stored video information may be retrieved and further processed in the processor system 136, which may include such processes as, for example, sorting and reassembling received blocks of video information, to reconstruct sequentially ordered, high resolution, full length, movie data (e.g., in an MPEG-4 format) which a user can then access to watch the video/movie with full VCR functionality. The user intending to watch a movie from a list of movies downloaded (or otherwise pre-loaded) to the storage device 134 may, in one exemplary embodiment, call the central computer system 110 and request activation codes from the AAS 104 (FIG. 2). The AAS 104 also collects user information, such as, for example, name, address and contact information, billing information including credit card or other modes of payment information before releasing activation codes to the requesting user.

The released authorization codes are forwarded to encoding and distribution system (EDS) 106 for broadcast to the user's STB 130. The authorization codes are received by processor system 136 where the encrypted video information stored in the storage device 134 is processed for display, after verifying the authenticity of the received authorization code(s), on display device 140, such as for example, a television receiver. The movie is displayed in a full length high-quality high-resolution format while enabling the user to watch the movie with complete VCR functionality.

FIG. 5 shows a second exemplary embodiment where elements in common with the system of FIG. 3 are indicated by similar reference numerals, but with the prefix “2” added. Here, each of a plurality of FM receivers 232 of STB 230 are enabled to receive encrypted video information transmitted on one or more FM subcarrier channel(s), for downloading to storage device 234. Thus, STB 230 is capable of downloading one or more distinct movies simultaneously transmitted on one or more corresponding FM subcarrier channels. High capacity storage device 234 still slowly becomes populated with a large number of complete high quality movies—although faster than compared to receiving video information using an STB having a single FM receiver as video information is now received in parallel on a plurality of FM subcarrier channels. By utilizing more than one sub carrier, a single movie may be divided into several blocks of video data, each block of video data being transmitted on more than one distinct FM subcarrier channel to be received by FM receivers 232 tuned to corresponding FM subcarrier channels. In this approach, a single movie, divided into several video data blocks, may be transmitted and received in parallel, thus reducing the amount of time it would otherwise take to download the movie using a single FM receiver, or different movies could be downloaded on each sub carrier. In other cases, more movies are downloaded per unit of time to the STB.

Further, each STB 230 may be provided with an option of receiving live television broadcasts (e.g., received over the air, cable or satellite) by providing at least one television tuner 231 (e.g., for analog NTSC or digital ATSC, HDTV signaling formats) to receive those broadcasts, while FM receiver(s) are downloading encrypted video information transmitted from FM transmitter(s) 126.

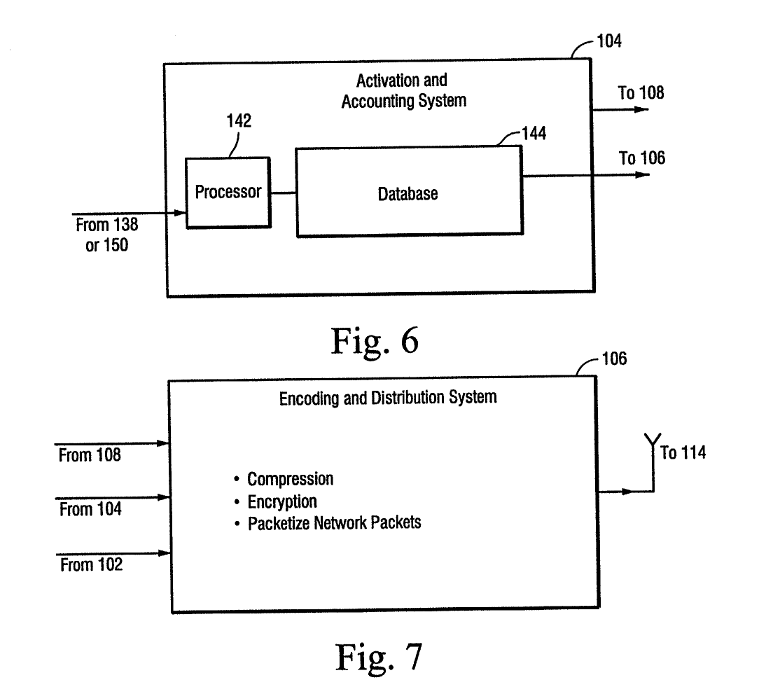

FIG. 6 shows details of an exemplary activation and accounting system (AAS) 104 (FIG. 2). The AAS 104 preferably includes a processor 142 (e.g., with a speech recognition and response front end) communicatively coupled to a database system 144. As noted above with respect to FIG. 2, when a user requests activation code(s) via a telephone line 150 (FIG. 1), processor 142 processes the user's request and generates and forwards one or more activation code(s) to the requesting user. The processor unit 142 may include, for example, a voice recognition unit (VRU), a dual tone multi-frequency (DTMF) system, or an e-mail message processing system (e.g., so that users can request activation codes via voice, key pad or email communications). Electronic message(s) may be communicated via a packet switching network, such as, for example, Internet, or any other communication network. Upon receiving a request (via any communication modality) for activation code(s) from a user, the request is processed by retrieving user information stored in the database system 144, and upon collecting a fee from the user (or otherwise insuring for proper payment), one or more activation codes may be transmitted to the user via smart router 125 (FIG. 2).

FIG. 7 illustrates the details of an exemplary encoding and distribution system (EDS) 106 as shown in FIG. 2. The encoding and distribution system 106 receives video information from source(s) 108, activation code and accounting information from AAS 104, as well as program listings information received from source 102. If the video or movie is not already digitized, it may be digitized at EDS 106. The EDS 106 also is capable of performing compression and encryption tasks as well as creating network packets of received information for transmission to one or more STBs via satellite 114 and FM subcarrier channels of FM radio station(s) 120. The processor system 136 (FIG. 3) of STB 130 decrypts and reassembles the received network packets created by the EDS 106.

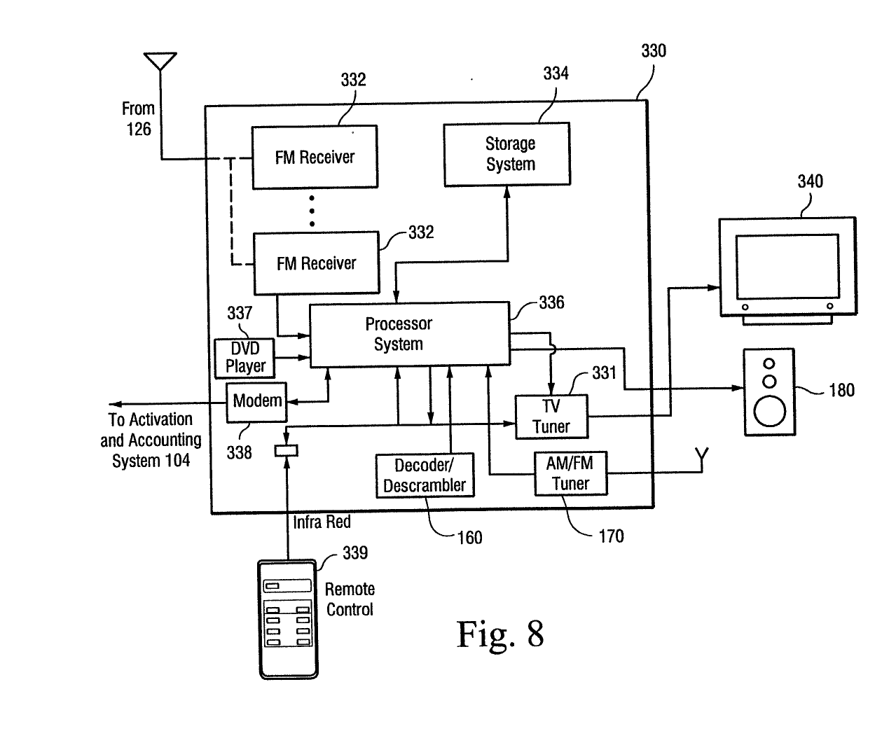

FIG. 8 shows another exemplary embodiment where elements in common with the system of FIG. 5 are indicated by similar reference numerals, but with the prefix “3” added. Here, the STB 330 includes a decoder/descrambler 160 which receives information from a source transmitting cable television signals at real-time or greater than real-time transmission speeds. The processor system 336 receives signals decoded or descrambled by the decoder 160 for processing and display on a display system 340 while FM receiver(s) 332 are continuously downloading video information carried by FM subcarrier channels for processing and storage in the storage system 334. The received cable television signals may also be processed for storage in the storage device 334. The STB 330 may further include an AM/FM tuner 170 for receiving simultaneous radio broadcasts while FM receiver(s) are receiving video information on FM subcarrier channels. The STB 330 may have a provision to connect a speaker device 180 for enabling a user of the STB 330 to listen to radio transmissions. Thus, each STB 330 may be provided with a capability to receive not only encrypted video transmissions in non-real time (low data-rate and less than real-time transmission speeds), but also television broadcasts in real-time, and cable broadcasts at greater than real time (at a very high data rate).

A DVD player 337 may also be provided as part of the STB. This provides another source for data input and/or for simply playing a DVD for direct display on the attached television.

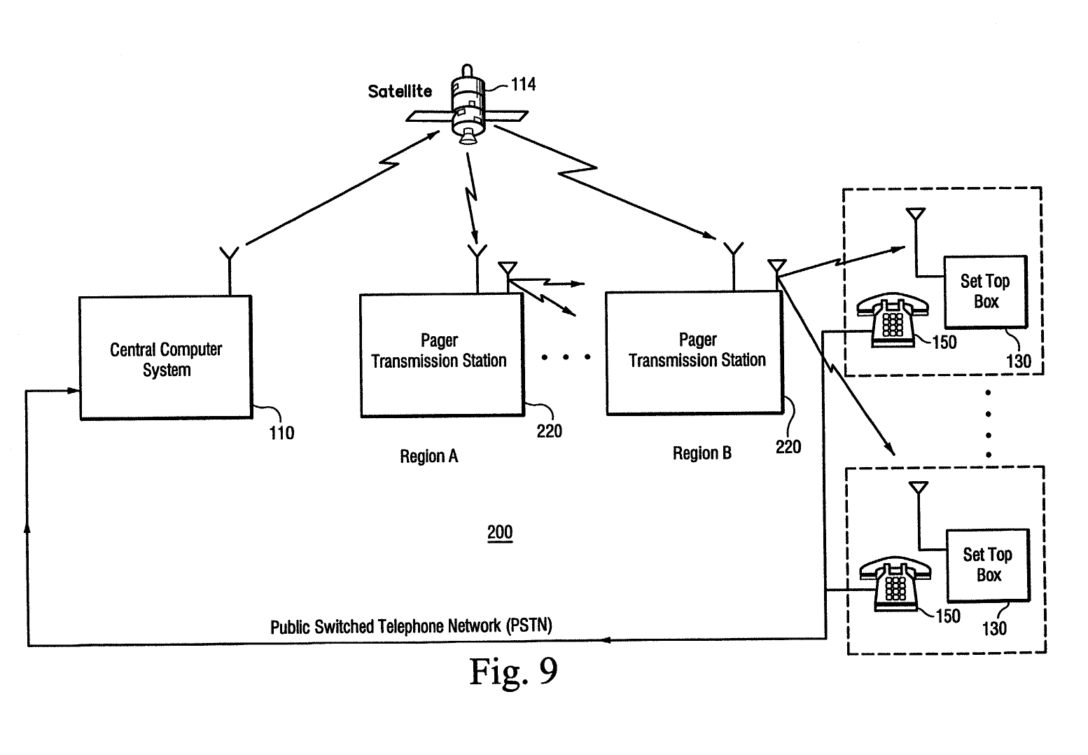

FIG. 9 shows another exemplary embodiment of the present invention where elements in common with the system of FIG. 1 are indicated by similar reference numerals. Here, video information processed by central computer system 110 is transmitted to satellite 114 for retransmission to a plurality of pager band transmission stations 220. Each of the pager transmission stations 220 may be located to cover a corresponding geographic region, or a portion of a geographic region. Thus, video information relayed from satellite 114 may be further re-transmitted via one or more paging band frequencies over wide-ranging geographic regions. The operation of the rest of the system 200 is similar to the operation of system 100 and as in FIGURE land is therefore not repeated.

While the invention has been described in connection with what is presently considered to be the most practical and preferred exemplary embodiments, those in the art will recognize that there are many obvious variations and modifications that may be made to thse embodiments while yet retaining some or all of the novel advantages of this invention. It will be understood that the invention is not limited to the disclosed exemplary embodiments, but on the contrary, is intended to cover all modifications and equivalent arrangements included within the spirit and scope of the appended claims.

What is claimed is:

1. A wireless video-on-demand method, said method comprising:
broadcasting high-resolution video data in non-real time on one or more wireless broadcast channels; and
receiving and locally accumulating video data transmitted on at least one wireless broadcast channel for subsequent controlled access viewing in real-time.

2. A method as in claim 1 further comprising:
centrally receiving high resolution video data from at least one video source; and
transmitting said video data to a plurality of broadcast transmitter stations for re-transmission.

3. A method as in claim 2, wherein said centrally receiving step comprises:
selectively providing activation codes to a selected remote user via said at least one broadcast channel.

4. A method as in claim 3 further comprising:
monitoring demand for activation codes from a plurality of remote users.

5. A method as in claim 4 wherein transmission of video data and activation code data streams are dynamically balanced depending on user demand.

6. A method as in claim 3 wherein said selectively providing activation codes comprises:
processing at least one of (a) voice calls from a remote user, (b) e-mail messages from a remote user, (c) communications via modem of a receiver unit, or (d) cellular communications from a receiver unit; and
accessing a data base system storing user information.

7. A method as in claim 6 wherein said processing comprises processing voice calls using a voice recognition system.

8. A method as in claim 6 wherein said user information includes user contact information and billing details.

9. A method as in claim 1 wherein plurality of movies are transmitted in said broadcasting step, and said receiving step comprises:
receiving video data carried by at least one broadcast channel;
selectively receiving television or cable broadcasts;
accumulating and storing said received video data in a high capacity storage device, where the storage capacity required for the number of movies being transmitted exceeds the storage capacity of said high capacity storage device; and
communicating with an activation and accounting system to receive activation codes.

10. A method as in claim 9 further comprising:
processing the stored video data; and
selectively enabling a user to display processed video data on a display device.

11. A method as in claim 10 wherein the user is enabled to display video data after receiving one or more activation codes.

12. A method as in claim 10 wherein said processing includes reconstructing said received video data.

13. A method as in claim 1 wherein high-resolution video data is transmitted at about 100 kilobits per second or less on an FM subcarrier.

14. A method as in claim 2 wherein video data is transmitted to said transmitter stations via a wireless communications network.

15. A method as in claim 2 wherein video data is transmitted to said transmitter stations via a satellite.

16. A method as in claim 10 wherein said processing comprises enabling the user to selectively delete video data stored in the high capacity data storage device.

17. A method as in claim 10 wherein said processing comprises purging video data from high capacity data storage device on a first-in-first-out basis.

18. A method as in claim 10 wherein said processing performs at least one of (a) sorting, (b) rearranging, and (c) reassembling stored video data.

19. A method as in claim 12 wherein said processing performs at least one of (a) fast forward, (b) fast reverse, (c) pause, (d) stop, (e) forward, (f) rewind, and (g) freeze frame functions with respect to display of said accumulated video data.

20. A method as in claim 2 wherein said centrally receiving step comprises encrypting said received video data.

21. A method as in claim 20 wherein activation codes are routed to corresponding receiver units.

22. A wireless video-on-demand system, said system comprising:
a plurality of FM broadcast stations, each said FM station transmitting high resolution video data in non-real time on one or more FM subcarrier frequencies; and
a plurality of distributed receiver units located within a broadcast coverage area of at least one said FM station, each receiver unit receiving and accumulating for local storage said video data transmitted on at least one FM subcarrier frequency for subsequent controlled access viewing in real-time.

23. A system as in claim 22 further comprising:
a central controller receiving high-resolution video data from at least one video source and transmitting same to said plurality of FM broadcast stations.

24. A system as in claim 23, wherein said central controller comprises:
an activation and accounting system for selectively providing activation codes to a selected remote user; and
a video data encoding and distribution system for encrypting video data and activation codes.

25. A system as in claim 23, wherein said central controller monitors demand for activation codes from a plurality of remote users.

26. A system as in claim 23, wherein said central controller dynamically balances transmission of video data and activation code data streams depending on user demand.

27. A system as in of claim 24, wherein said activation and accounting system comprises:
means for processing at least one of (a) voice calls from a remote user, (b) e-mail messages from a remote user, (c) communications via modem of each receiver unit, or (d) cellular communications from each receiver unit; and
a database system for storing user information.

28. A system as in claim 27, wherein said activation and accounting system comprises a voice recognition system.

29. A system as in claim 27, wherein said user information includes user contact information and billing details.

30. A system as in claim 22, wherein said broadcast stations transmit a sufficient plurality of movies to collectively exceed the capacity of each individual receiver unit, and each said receiver unit comprises:
at least one FM-receiver capable of receiving digital data carried by at least one FM subcarrier frequency;
at least one television tuner for receiving television broadcasts;
at least one radio receiver for receiving radio broadcasts;
a high capacity digital data storage device for storing video data, said video being selectively received by a user from the transmitted movies; and
a processor system for processing and accumulating received video data into said storage device, said processor system further enabling a user to display stored video data.

31. A system as in claim 24, further comprising:
means for communicating with an activation and accounting system.

32. A system as in claim 31 wherein the user is enabled to display stored video data after receiving activation codes.

33. A system as in claim 30, wherein said processor system controls playback and display of said video data.

34. A system as in claim 22 wherein high-resolution video data is transmitted at a data-rate of about 100 kilobits per second or less.

35. A system as in claim 22 wherein video data is transmitted from said central controller to said FM stations via a wireless communications network.

36. A system as in claim 22 wherein video data is transmitted from said central controller to said FM stations via a satellite.

37. A system as in claim 30 wherein said processor system is capable of selectively deleting video data stored in said storage device.

38. A system as in 30 wherein said processor system is capable of purging video data from said data storage device on a first-in-first-out basis.

39. A system as in claim 30 wherein said processor system is capable of performing at least one of (a) sorting, (b) rearranging, and (c) reassembling of stored video data.

40. A system as in claim 30 wherein said processor system is capable performing at least one of (a) fast forward, (b) fast reverse, (c) pause, (d) stop, (e) forward, (f), rewind, and (g) freeze frame functions with respect to display of said accumulated video data.

41. A system as in claim 24 wherein each said FM station comprises:
a receiver for receiving encrypted video data transmitted from said encoding and distribution system; and
a processor for processing received video data for retransmission via one or more FM subcarrier frequencies.

42. A system as in claim 41 wherein said processor comprises an intelligent router for selectively routing activation codes to corresponding ones of said receiver units.

43. A wireless video-on-demand system, comprising:
a central computer system, said central computer system comprising means for encoding and transmitting video information to one or more wireless broadcast stations, each said wireless broadcast station receiving and retransmitting said video information on one or more wireless broadcast channels in non-real time;
an activation and accounting system for providing activation codes to a remote user; and
a plurality of distributed receiver units capable of receiving and locally accumulating said video information for storage, processing, and display.

44. A system as in claim 43 wherein said central computer system monitors demand for activation codes from a plurality of remote users.

45. A system as in claim 43 wherein said central computer system dynamically balances transmission of video data and activation code data streams depending on user demand.

46. A system as in claim 43 wherein said activation and accounting system comprises:
means for processing at least one of (a) voice calls from a remote user, (b) e-mail messages from a remote user, (c) communications via modem of each receiver unit, or (d) cellular communications from each receiver unit; and
a database system storing user information.

47. A system as in claim 43 wherein said activation and accounting system comprises a voice recognition system.

48. A system as in claim 46 wherein said user information includes user contact information and billing details.

49. A system as in claim 43 wherein each receiver unit comprises:
at least one receiver for scanning a wireless broadcast spectrum;
at least one television tuner for receiving television broadcasts;
an AM/FM tuner for receiving radio broadcasts;
a decoder for receiving and decoding cable television broadcasts;
a high capacity storage device for storing video data; and
a processor system for processing and accumulating video data in said storage device, said processor system further enabling a user to display processed and accumulated video data.

50. A system as in claim 49 further comprising:
means for communicating with said activation and accounting system.

51. A system as in claim 50 wherein the user is enabled to display stored video data after receiving activation codes.

52. A system as in claim 49 wherein said processor system controls playback and display of the video data.

53. A video communications system, comprising:
a first system for encoding and transmitting video information to remote broadcasting stations, each said broadcasting station further comprising a processor having an intelligent router for selectively routing activation codes to a remote user, said activation codes being broadcast on one or more wireless broadcast channels in non-real time; and
a second system having one or more wireless broadcast receivers, each receiver being capable of receiving and gradually accumulating said video information in a local high capacity storage device, said receiver being further capable of processing stored video information for controlled access and real time playback of previously stored information.

54. A system as in claim 53 wherein said first system further comprises:
an accounting system for receiving remote user account information and performing accounting functions; and
an activation system for generating and forwarding activation codes to a selected remote user upon verifying accounting information of the selected remote user.

55. A system as in claim 54 further comprising:
a communication means for communicatively coupling said remote user to said accounting system.

56. A method of communicating video information in a wireless video-on-demand system, said method comprising:
a) transmitting video information from a central computer system to a plurality of wireless broadcast stations;
b) retransmitting the video information, received by each wireless broadcast station, in non-real time on one or more wireless broadcast carrier frequencies;
c) receiving the video information transmitted on one or more carrier frequencies by a plurality of distributed receiver units;
d) accumulating and locally storing the received video information in a high capacity storage device of each receiver; and
e) processing stored video information for controlled access real time display on a display device.

57. A method as in claim 56 wherein step a) further comprises:
a1) receiving video information from at least a video source; and
a2) encrypting the video information.

58. A method as in claim 57 further comprising:
a3) receiving activation codes from an activation and accounting system; and
a4) encrypting and transmitting activation codes to said plurality of wireless broadcast stations.

59. A method as in claim 58 further comprising:
a5) retransmitting the activation codes via an intelligent router on one or more broadcast carrier frequencies to a selected receiver unit among the plurality of corresponding receiver units.

60. A method as in claim 56 wherein step b) further comprises:
b1) dynamically balancing transmission of video information and requests for activation codes.

61. A method as in claim 56 wherein step e) further comprises:
e1) receiving activation codes in a selected receiver unit; and
e2) authenticating received activation codes prior to processing stored video information.

62. The method as in claim 56, wherein step (e) includes processing video information to provide full VCR functionality.

63. A method of communicating video information in a video-on-demand system, said method comprising:
a) transmitting video data and activation code data to a plurality of wireless broadcast stations;
b) retransmitting the video data from said plurality of broadcast stations in non-real time;
c) transmitting activation code data to a selected receiver unit among a plurality of corresponding receiver units;
d) receiving retransmitted video data as in step b) in each of a plurality of distributed receiver units;
e) receiving activation codes at the selected receiver unit;
f) accumulating and locally storing received video data as in step d) in a high capacity storage device of each receiver unit;
g) processing stored video data in the selected receiver unit upon verifying the authenticity of activation codes selectively thereat; and
h) displaying the processed video data in real time on a display device with controlled access.

64. The method as in claim 63, wherein step (h) includes displaying the processed video data in real-time on a display device with full VCR functionality.

65. A video-on-demand system, said system comprising:
a) means for transmitting video data and activation code data to a plurality of wireless broadcast stations;
b) means for retransmitting the video data from said plurality of wireless broadcast stations in non-real time;
c) means for selectively transmitting activation code data to a selected receiver unit among a plurality of corresponding receiver units;
d) means for receiving retransmitted video data as in step b) in each of a plurality of distributed receiver units;
e) means for receiving activation codes at the selected receiver unit;
f) means for accumulating and locally storing received video data as in step d) in each receiver unit;
g) means for processing stored video data in the selected receiver unit upon verifying the authenticity of activation codes selectively thereat; and
h) means for displaying the processed video data in real time with controlled access.

66. The system as in claim 65, further comprises:
(i) means for displaying the processed video data in real time with full VCR functionality.

67. An integrated video communications controller apparatus, said apparatus comprising:
at least one wireless broadcast receiver capable of receiving video data transmitted in non-real time;
at least one television tuner for receiving live television broadcasts transmitted in real-time;
a decoder for receiving cable television signals transmitted in at least real-time;
at least one radio receiver for receiving broadcasts;
a high capacity digital data storage device for storing one or more of (a) video data, (b) live television signals, and (c) cable television signals; and
a processor system for processing and accumulating one or more of (a) received video data, (b) live television signals, (c) cable television signals, into said storage device, said processor system further enabling a user to control the real time display of information stored in the storage device.

68. An integrated receiver for receiving information transmitted from different sources, said apparatus comprising:
one or more wireless broadcast receivers capable of receiving video data transmitted in non-real time from a first source;
at least one television tuner for receiving live television broadcasts transmitted in real-time from a second source;
a decoder for receiving cable television signals transmitted in at least real-time from a third source;
an AM/FM tuner for receiving broadcasts;
a high capacity data storage device for storing received information from one or more said first, second, or third sources, respectively; and
a processor system for accumulating and processing said received information into said storage device, said processor system further enabling controlled real time display of information stored in the storage device.

69. A method of controlling storage and display of video information using an integrated video communications controller, said method comprising:
receiving video data transmitted in non-real time;
receiving live television broadcasts transmitted in real-time;
receiving cable television signals transmitted in at least real-time;
receiving radio broadcasts;
storing one or more of (a) video data, (b) live television broadcasts, and (c) cable television signals; and
processing and accumulating one or more of (a) received video data (b) live television broadcasts, and (c) cable television signals, into said storage device, said processor system further enabling a user to control the real time display of information stored in the storage device.

70. A wireless video-on-demand method, said method comprising:
transmitting high-resolution video data in non-real time on one or FM subcarrier frequencies; and
receiving and locally accumulating video data transmitted on at least one FM subcarrier frequency for subsequent controlled access viewing in real-time with full VCR functionality.

71. A wireless video-on-demand method, said method comprising:
transmitting high-resolution video data in non-real time using one or more paging band frequencies; and
receiving and locally accumulating video data transmitted on at least one paging band frequency for subsequent controlled access viewing in real-time with full VCR functionality.

72. A method of controlling storage and display of video information using an integrated video communications controller, said method comprising:
receiving video data transmitted in non-real time on one or more paging band frequencies;
receiving live television broadcasts transmitted in real-time;
receiving cable television signals transmitted in at least real-time;
receiving radio broadcasts;
storing one or more of (a) video data, (b) live television broadcasts, and (c) cable television signals; and
processing and accumulating one or more of (a) received video data (b) live television broadcasts, and (c) cable television signals, into said storage device, said processor system further enabling a user to control the real time display of information stored in the storage device.

73. A wireless video-on-demand system, comprising:
a central computer system, said central computer system comprising means for encoding and transmitting video information to one or more paging transmitter stations, each said paging transmitter station receiving and retransmitting said video information on one or more paging band frequencies in non-real time;
an activation and accounting system for providing activation codes to a remote user; and
a plurality of distributed receiver units capable of receiving and locally accumulating said retransmitted video information for storage, processing, and display.
